(19) United States
(12) Patent Application Publication
(10) Pub. No.: US 2004/0029645 A1
(43) Pub. Date: Feb. 12, 2004

(54) Lip edge grip tape and method of making a gripping surface

(76) Inventor: Sam H. Chen, San Diego, CA (US)

Correspondence Address: CALIF KIP TERVO, 6387 CAMINITO LAZARO, SAN DIEGO, CA, 92111, US

(21) Appl. No.: 10/217,265

(22) Filed: Aug. 8, 2002

(51) Int. Cl. A63B 53/14; B32B 7/12

(52) U.S. Cl. 473/300; 428/343; 473/302

(57) ABSTRACT

Grip tape (10) for wrapping around a handle (85) for improving the grip and absorbing shock, made by attaching a flexible, stretchy upper skin (30) to top face (21) of lower cushion (20). Upper skin (30) includes lip part (36) extending laterally from supported part (31) Lip part (36) deforms upon elongation of grip tape (10) so as to cause free edge (37) of lip part (36) to curl downward as grip tape (10) is stretched during wrapping, thus protecting free edge (37) from rolling up or tearing

### FIELD OF THE INVENTION

This invention relates in general to grips for handles, and more particularly to an improved grip tape for wrapping around a handle, such as of a golf club, tennis racquet, or bat

### BACKGROUND OF THE INVENTION

Grip tape for wrapping a racquet handle to enhance grip and to reduce shock is well-known. Grip tapes have been made of leather, rubber, and plastic. One type of conventional grip tape comprises a layer of polyurethane backed with a layer of felt The felt layer is generally thicker than the polyurethane layer and provides part of the elasticity, strength, cushioning, and shock resistance The polyurethane layer provides a tacky gripping surface and part of the cushioning and shock resistance.

Grip tape is typically wrapped helically around the gripping portion of a handle. One of the main problems encountered when making a grip on a handle by wrapping grip tape around it is that the edges of the grip tape tend to roll or curl. Various methods of preparing or wrapping the grip tape have been developed to mitigate this problem.

One means for overcoming the edge roll problem is skiving the tape, that is, tapering the edges with a blade so that edges overlap smoothly on successive turns of the tape about the handle and so that the edges are thinner and less blunt, making them less likely to roll. Skiving can lead to other problems, though, due to the great precision with which the skiving operation must be done In actual practice, the skiving blade can wander, causing a wavy edge Even a perfectly skived edge is weak and prone to splitting.

When wrapping the skived tape, each turn must overlap the previous turn rather precisely or the benefit of skiving is lost Most skived grip tapes have about the outer 2 millimeters of the edge beveled, and turns of the tape are preferably overlapped by 0 5 to 10 millimeters If a gap is left between turns or the overlap is too small, the weak edges are exposed to abrasion and rolling. If successive turns of the grip tape overlap too much, a ridge or lump is formed in the gripping surface.

Therefore, there is a need for a grip tape that provides an excellent grip and resists rolling of the edges. There is further a need for grip tape that can be manufactured cheaply, without difficult or high-precision operations There is further a need for a grip tape that is adaptable to modifications of dimension and wrapping technique to provide a range of different grip surfaces for different needs. There is further a need for a grip tape that can be wrapped easily by a user with dependable results

### SUMMARY OF THE INVENTION

This invention is a grip tape that is wrapped around the grip portion of a handle, such as of a golf club, to improve a user's grip and to dampen shock. The tape has an upper skin of stretchy, tacky material, such as polyurethane coated felt, and a shock absorbing lower cushion, such as of closed cell EVA elastomer foam

The material of the upper skin is non-uniform in cross section, being purely polyurethane near the upper surface and purely felt near the bottom surface The central, or “supported”, part of the upper skin is attached to the top face of the lower cushion, such as by double-sided adhesive tape. A lip extends laterally from at least one side of the supported part of the upper skin attached to the lower cushion

Due to the composition gradient of the upper skin, the uppermost surface of the upper skin is stretchier than the underside of the lip, so the free edge of the lip curls downward if the grip tape is stretched.

The grip tape is stretched slightly as it is wrapped around the handle to form a grip The free edge or edges of the lip part curl under and are protected from being rolled up or torn.

The grip tape of the present invention can be manufactured relatively cheaply and does not require special precision operations such as skiving. Unlike skived tape, the present grip tape is wrapped without high precision and may be wrapped with a gap between turns Even with a gap, the curled down edges do not roll up during use and are resistant to tearing. The edges are stronger than those of skived tape.

The features and advantages of the invention will be readily understood when the detailed description thereof is read in conjunction with the accompanying drawings in which like reference numerals refer to like parts throughout

### BRIEF DESCRIPTION OF THE DRAWINGS

FIG. 1 is a perspective environmental view of the grip tape in use wrapped on the handle of a golf club.

FIG. 2 is an enlarged view, partly cut away, of the grip tape being wrapped on the handle of the golf club of FIG. 1.

FIG. 3 is a transverse cross-sectional view, partially cut away, of a preferred embodiment of the grip tape.

FIG. 4 is a transverse cross-sectional view, partly cut away, of two turns of another preferred embodiment of the grip tape wrapped on a handle

FIG. 5 is a transverse cross-sectional view, partly cut away, of two turns of a third preferred embodiment of the grip tape wrapped on a handle.

FIG. 6 is a transverse cross-sectional view, partly cut away, of the preferred embodiment of grip tape of FIG. 2, taken along line 6-6 of FIG. 2.

FIG. 7 is a transverse cross-sectional view, partly cut away, of the gap between two successive turns of the embodiment of FIG. 6.

### DETAILED DESCRIPTION OF THE INVENTION

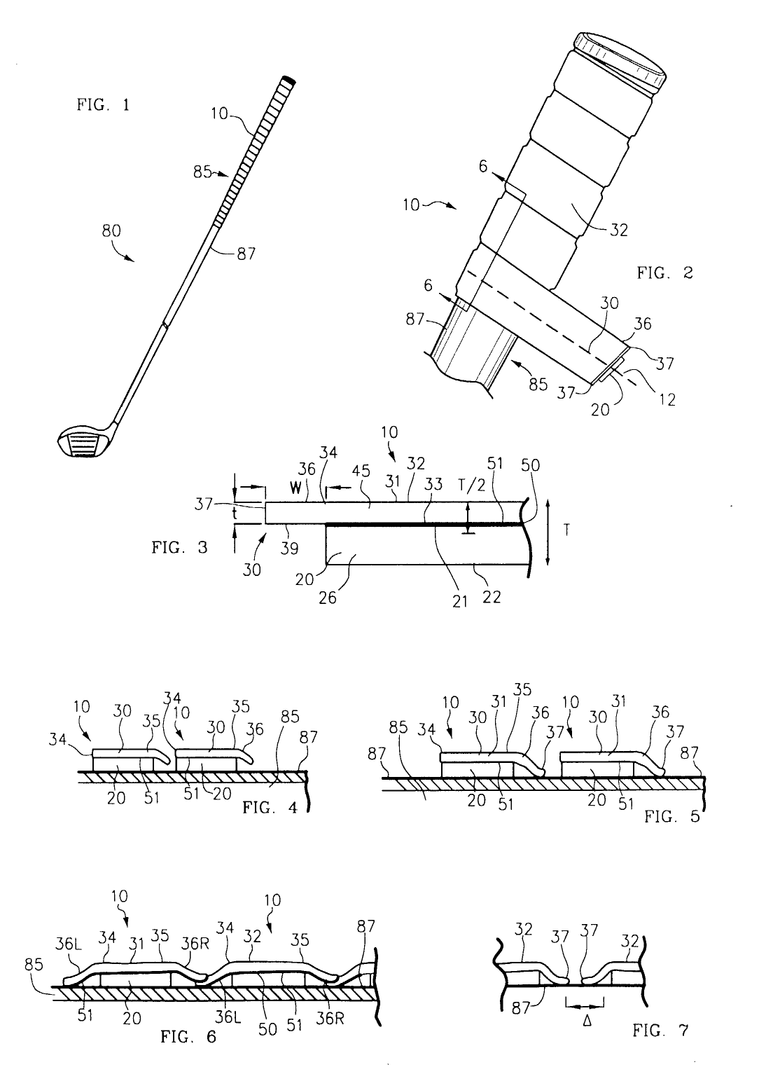

FIG. 1 is a perspective environmental view of the grip tape 10 in use wrapped on the handle 85 of a golf club 80. FIG. 2 is an enlarged view, partly cut away, of grip tape 10 being wrapped upon handle 85 of golf club 80 FIG. 3 is a transverse cross-sectional view, partly cut away, of a preferred embodiment of grip tape 10.

Grip tape 10 includes lower cushion 20 and upper skin 30, which are typically attached together by an adhesive layer 50, such as double-sided adhesive tape 51, between them.

Lower cushion 20 includes a top face 21 and a bottom face 22 that is placed against surface 87 of gripping portion 86 Lower cushion 20 provides shock absorption and cushioning for the hands during an impact, such as striking a golf ball with golf club 80 Lower cushion 20 may be made of any material that provides cushioning and is resistant to outdoor conditions and perspiration. Typical materials used are polyurethane or EVA closed cell foam 26, natural rubber, and felt.

Upper skin 30 is attached to top face 21 of lower cushion 20 by an adhesive layer 50, such as double-sided adhesive tape. Upper skin 30 includes a supported part 31 that is attached to lower cushion 20 and a lip part 36 that is unsupported and extends outward from supported part 31 Lip part 36 includes free edge 37 and underside 39.

Upper skin 30 also includes an upper surface 32 that contacts the hand and is tacky to provide a good grip, even when damp. Bottom surface 33 of supported part 31 is attached to top face 21 of lower cushion 20 by adhesive tape 51 One preferred method of manufacture of grip tape 10 is to apply adhesive tape 51 to cover top face 21, then to place upper skin 30 over adhesive tape 51. This method results in all of adhesive tape 51 being sandwiched between upper skin 30 and lower cushion 20. Another preferred method of manufacture is to apply adhesive tape 51 to the entire bottom of upper skin 30, that is, to bottom surface 33 and underside 39 of lip part 36. This method of manufacture results in exposed adhesive tape 51 on underside 39 after upper skin 30 and lower cushion 20 have been attached together. Both methods are useful for various types of handle grips

Upper skin 30 is preferably composed of material that is flexible, slightly stretchy, and that tends to curl or cup downwardly when stretched This combination of properties can be created by attaching a very stretchy layer over a less stretchy layer, such as a thin layer of rubber or synthetic rubber attached to a thin layer of felt, jute fabric, or a relatively non-stretchy foam rubber.

In the preferred embodiment illustrated, upper skin 30 is a single layer of material, such as polyurethane-coated felt 45, that has a gradient of elongation, that is, it is stretchy toward upper surface 32 and less stretchy toward bottom surface 33 Polyurethane-coated felt 45 is prepared by dipping one side of a felt strip into a bath of liquid precursors of polyurethane rubber The liquid is absorbed into the felt strip and subsequently cured to form polyurethane rubber. As a result of the polyurethane being applied from one side, the resulting cured polyurethane-coated felt 45 has composition and elongation gradients from upper surface 32 to bottom surface 33. Upper surface 32 is pure polyurethane rubber without fiber reinforcing, and is therefore tacky and very stretchy. Bottom surface 33 exhibits free fibers of felt protruding from a matrix of fibers embedded in polyurethane Bottom surface 33 therefore is less stretchy and adheres well to adhesive tape 51 The felt or other fibers reinforce the polyurethane rubber, in addition to moderating the elongation, and help keep the rubber from tearing

The elongation gradient causes polyurethane-coated felt 45 to deform when stretched along longitudinal axis 12. Instead of simply becoming thinner when stretched, as pure polyurethane rubber does, polyurethane-coated felt 45 cups convexly, transverse to longitudinal axis 12 Free edge 37 of lip part 36 curls downward

FIG. 3 is a transverse cross-sectional view of a preferred embodiment of grip tape 10 Grip tape 10 has a total thickness T and upper skin 30 has a thickness t T/2 denotes half the thickness of grip tape 10. Lip part 36 extending out from supported part 31 has a width W. The optimal values for T, t, and W depend upon the application and the physical properties of the materials, especially the hardness and elongation of upper skin 30. It has been found to be preferable that W be greater than T/2 and that t be less than T/2. For grip tape intended for use on golf clubs and sports racquets, T is typically in the range of 1.0 to 2.5 millimeters, and W is typically in the range of 8 to 35 millimeters.

FIGS. 4 through 6 depict different embodiments of grip tape 10, with lip part 36 extending from right side 35 or from both sides 34,35, and having various widths of lip part 36. Grip tapes 10 are shown as transverse cross-sectional views of two turns 10B, 10A of grip tape 10 wrapped on a handle 80. Supported part 31 includes a left side 34 and a right side 35 A lip part 36 may extend from either, or both, sides 34,35

FIG. 4 illustrates an embodiment of grip tape 10 wherein W is less than T and turns 10B, 10A around handle 80 are spaced apart by greater than W. Free edges 37 are downturned below upper surface 32 due to the differential stretching discussed above and so are protected from being rolled or torn. The gap between turns 10A, 10B improves the grip of a hand and provides ventilation for moisture.

FIG. 5 illustrates an embodiment of grip tape 10 wherein W is somewhat greater than T. As grip tape 10 is stretched and wrapped around handle 80, lip part 36 curls down until free edge 37 collides with surface 87 of gripping portion 86 of handle 80. Because supported part 31 stiffens attached edge 38, lip part 36 does not bow upward upon collision with surface 87 Instead, free edge 37 deforms along surface 87 Free edge 37 is very well protected against rolling or tearing.

FIG. 6 is a transverse cross-sectional view, partly cut away, of the preferred embodiment of grip tape 10 of FIG. 2, taken along line 6-6 Left lip part 36L extends from left side 34 of supported part 31 and right lip part 36R extends from right side 35 The spacing between successive turns 10B, 10A is less than twice W, so that right lip part 36R of turn 10A overlies left lip part 36L of turn 10B

As can be appreciated from the drawings, grip tape 10 does not have to be wrapped precisely onto handle 80 in order that free edge 37 be protected from rolling up, tearing, or splitting For example, in the embodiment illustrated in FIG. 5, variation in the spacing of turns 10A, 10B could be as high as W without affecting the quality of the grip created by grip tape 10. Thus, for a grip tape 10 with a W of 2 millimeters, the wrapping is preferably done with a spacing of ⁺/−1.0 millimeters, instead of the ⁺/−0.25 millimeters required for conventional skived grip tapes.

FIG. 7 is a transverse cross-sectional view, partly cut away, of the gap between two successive turns 10A, 10B of the embodiment of FIG. 6. FIG. 6 shows right lip part 36R of turn 10A overlapping left lip part 36L of previous turn 10B. FIG. 7 shows successive turns 10A, 10B spaced farther apart such that lip parts 36L, 36R do not overlap. The distance Δ is the allowable variation of spacing of turns 10A, 10B without degrading the grip performance or the durability of the grip produced with grip tape 10.

I claim:

1. An elongate grip tape having a longitudinal axis for wrapping a handle, including
a lower cushion, including:
a top face; and
a bottom face for contacting the handle; and
an upper skin for gripping by a hand, including:
a supported part; including
an upper surface for contact with the hand; and
a bottom surface attached to said top face of said lower cushion, and
a lip part attached to and extending laterally from said supported part, including
a free edge parallel to the longitudinal axis, and
an underside,
said upper skin being of a material that deforms under elongation such that said free edge deflects downward relative to said supported part when said grip tape is elongated along the longitudinal axis.

2. The grip tape of claim 1, said lip part having a width that is greater than half the thickness of said grip tape

3. The grip tape of claim 1, said lip part having a width that is greater than the thickness of said grip tape.

4. The grip tape of claim 2, the thickness of said grip tape being in the range of 1.0 to 2.5 millimeters

5. The grip tape of claim 4, the width of said grip tape being in the range of 8 to 35 millimeters.

6. The grip tape of claim 1, said lower cushion being attached to said bottom surface of said supported part by an adhesive layer that substantially covers said top face of said lower cushion.

7. The grip tape of claim 1, said lower cushion being attached to said bottom surface of said supported part by an adhesive layer that substantially covers said bottom surface of said supported part and said underside of said lip part.

8. The grip tape of claim 1, said upper skin including an elongate strip of polyurethane-coated felt.

9. An elongate grip tape having a longitudinal axis for wrapping a handle, including:
a lower cushion, including:
a top face; and
a bottom face for contacting the handle; and
an upper skin for gripping by a hand, including.
a supported part; including.
an upper surface for contact with the hand; and
a bottom surface attached to said top face of said lower cushion,
a left side, and
a right side,
a left lip part attached to and extending laterally from said left side; and
a right lip part attached to and extending laterally from said right side; each said lip part including
a free edge parallel to the longitudinal axis; and
an underside;
said upper skin being of a material that deforms under elongation such that each said free edge deflects downward relative to said supported part when said grip tape is elongated along the longitudinal axis

9. The grip tape of claim 8, each said lip part having a width that is greater than half the thickness of said grip tape and wherein said left lip part is wider than the thickness of said grip tape.

10. The grip tape of claim 8, each said lip part having a width that is greater than half the thickness of said grip tape and wherein said right lip part is wider than the thickness of said grip tape.

11. The grip tape of claim 8, each said lip part having a width that is greater than the thickness of said grip tape.

12. The grip tape of claim 8, the thickness of said grip tape being in the range of 1.0 to 2.5 millimeters.

13. The grip tape of claim 8, the width of said grip tape being in the range of 8 to 35 millimeters.

14. A method for creating a grip surface on a handle with grip tape, the handle having a generally cylindrical gripping portion including a surface; and the grip tape including an upper skin for gripping by a hand, including a supported part, including a bottom surface, and a lip part extending laterally from said supported part; including a top surface, an underside, and a free edge; and a lower cushion attached to said bottom surface of said supported part, including a top face contacting said supported part and a bottom face contacting the handle; said upper skin being of a material that cups convexly laterally when said grip tape is elongated, said method including the step of.
winding the grip tape helically around the gripping portion of the handle while applying sufficient elongation to the grip tape to cause the free edge of the lip part to curl convexly such that the free edge is disposed below the upper surface of the supported part in the finished grip surface

15. The method of claim 14, wherein the lip part is wider than the total thickness of the grip tape, the method further including the step of:
spacing apart each turn of the grip tape around the handle such that a gap is formed between successive turns of the grip tape and such that some of the lip part is disposed against the surface of the gripping portion of the handle

16. The method of claim 14, wherein the supported part includes a left side and a right side; and the upper skin includes a left lip part extending laterally from the left side and a right lip part extending laterally from the right side, and the method further including the step of.
spacing apart each turn of the grip tape around the handle such that a gap is formed between successive turns of the grip tape, and such that some of the lip part is disposed against and parallel to the surface of the gripping portion of the handle, and such that a free edge of a turn of grip tape is disposed substantially parallel and adjacent to a free edge of a prior turn of grip tape.

17. The method of claim 14, wherein the supported part includes a left side and a right side, and the upper skin includes a left lip part extending from the left side and a right lip part extending from the right side, and the method further including the step of
spacing apart each turn of the grip tape around the handle such that a gap is formed between successive turns of the grip tape; and such that some of the lip part is disposed against and parallel to the surface of the gripping portion of the handle; and such that the lip part of a turn of grip tape partly overlies a lip part of a prior turn of grip tape
